(19) United States
(12) Patent Application Publication
(10) Pub. No.: US 2011/0203301 A1
(43) Pub. Date: Aug. 25, 2011

(54) ABSORPTION CYCLE UTILIZING IONIC COMPOUNDS AND/OR NON-IONIC ABSORBENTS AS WORKING FLUIDS

(75) Inventors: Thomas Foo, Wilmington, DE (US); Konstantinos Kontomaris, Hockessin, DE (US); Steven Raymond Lustig, Landenberg, PA (US); Dennis A. Redder, Hockessin, DE (US); Mark A. Scialdone, West Grove, PA (US); Mark Brandon Shiflett, Wilmington, DE (US); Berlyn R. Mellein, Wilmington, DE (US); Megan Quigley, Aldan, PA (US)

(73) Assignee: E.I. DU PONT DE NEMOURS AND COMPANY, Wilmington, DE (US)

(21) Appl. No.: 13/126,214

(22) PCT Filed: Nov. 6, 2009
(86) PCT No.: PCT/US09/63599

§ 371 Date: Apr. 27, 2011

Related U.S. Application Data
(60) Provisional application No. 61/112,428, filed on Nov. 7, 2008.
(60) Provisional application No. 61/112,408, filed on Nov. 7, 2008.
(60) Provisional application No. 61/112,415, filed on Nov. 7, 2008.

(51) Int. Cl. F25B 15/00; C09K 5/04

(52) U.S. Cl. 62/101; 62/476; 252/69

(57) ABSTRACT

This invention relates to compositions comprising a refrigerant and at least one ionic compound and/or non-ionic absorbent, and also to devices capable of executing an absorption cycle using such compositions as a refrigerant pair. This invention also provides methods and apparatus for cooling using an absorption cycle comprising a refrigerant, and at least one ionic compound and/or non-ionic absorbent as the absorbent. This invention also provides methods and apparatus for heating using an absorption cycle comprising a refrigerant, and at least one ionic compound and/or non-ionic absorbent,

This application claims priority under 35 U.S.C. §119(e) from, and claims the benefit of, U.S. Provisional Application No. 61/112,408, filed Nov. 7, 2008; U.S. Provisional Application No. 61/112,415, filed Nov. 7, 2008; and U.S. Provisional Application No. 61/112,428, filed Nov. 7, 2008, each of which is by this reference incorporated in its entirety as a part hereof for all purposes.

### TECHNICAL FIELD

This invention relates to an absorption cooling or heating system utilizing a refrigerant pair that includes at least one refrigerant and at least one absorbent, wherein the absorbent in one particular embodiment may be at least one ionic compound and/or at least one non-ionic absorbent.

### BACKGROUND

The absorption cooling and heating cycle is a technique that is more than 100 years old, and is well known from descriptions such as that by Haaf et al in “Refrigeration Technology” (Ullmann's Encyclopedia of Industrial Chemistry, Sixth Edition, Wiley-VCH Verlag GmbH, Weinheim, Germany, Volume 31, pages 269-312). The basic cooling cycle uses a low-temperature liquid refrigerant that absorbs heat from water, air or any medium to be cooled, and converts to a vapor phase (in the evaporator section). The refrigerant vapors are then compressed to a higher pressure by a generator, converted back into a liquid by rejecting heat to the external surroundings (in the condenser section), and then expanded to a low-pressure mixture of liquid and vapor (in the expander section) that goes back to the evaporator section, and the cycle is repeated. An absorption system uses heat for compressing refrigerant vapors to a higher pressure.

Although the vapor compression cycle is now used in the majority of residential and small-scale commercial air-conditioning and refrigerating applications, refrigerant-absorber systems employing the well known refrigerant pairs of H₂O/LiBr and NH₃/H₂O are still being used for certain applications, particularly in the field of industrial operations or large-scale water chiller systems. Recently, more attention has been directed toward recovery of waste heat using the NH3/H₂O system (Erickson et al, Heat-Activated Dual-function Absorption Cycle, ASHRAE Trans., 2004, 110). Inherent drawbacks to using LiBr as an absorbent or NH₃ as a refrigerant include the corrosiveness of LiBr and the toxicity and flammability of NH₃.

Although U.S. Patent Applications No. 2006/0197053 and 2007/0144186, each of which is by this reference incorporated in its entirety as a part hereof for all purposes, disclose an absorption cycle wherein are utilized refrigerant pairs that include at least one refrigerant and at least one ionic compound, a need remains for systems to run an absorption cycle utilizing a selected pairs of refrigerants and ionic compounds and non-ionic absorbents.

### SUMMARY

This invention provides in part for the execution or performance of an absorption refrigeration cycle by operating or running a system or other equipment or apparatus that are suitable to accomplish heating or cooling in view of the heat rejected and absorbed during the repetition of the cycle.

One embodiment of this invention thus provides a composition that includes (a) a refrigerant selected from one or more members of the group consisting of water, a halocarbon, carbon dioxide (CO₂), ammonia (NH₃), and nonhalogenated hydrocarbon; and (b) at least one ionic compound and/or non-ionic absorbent that absorbs the refrigerant. These compositions are useful as a refrigerant pair in an absorption heating or cooling cycle, and in a system that operates such a cycle.

Another embodiment of this invention provides an apparatus for temperature adjustment that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser that receives the refrigerant vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator that receives the mixture of liquid and vapor refrigerant that passes through the pressure reduction device to evaporate the remaining liquid to form refrigerant vapor; and (f) a conduit that passes the refrigerant vapor leaving the evaporator back to the absorber.

Such an apparatus may be used for heating by locating the condenser in proximity to an object, medium or space to be heated, or the apparatus may be used for cooling by locating the evaporator in proximity to an object, medium or space to be cooled.

In a further embodiment, this invention provides a process for adjusting the temperature of an object, medium or a space by (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid; (d) reducing the pressure of the liquid refrigerant, and evaporating the refrigerant to form refrigerant vapor; and (e) repeating step (a) to re-absorb, with the absorbent, the refrigerant vapor.

In such a process embodiment, the temperature adjustment performed by the process may be an increase in temperature, and for that purpose refrigerant vapor is condensed to a liquid in proximity to an object, medium or space to be heated; or the temperature adjustment performed by the process may be a decrease in temperature, and for that purpose liquid refrigerant is evaporated in proximity to an object, medium or space to be cooled.

In any of the above embodiments, the refrigerant may be selected from one or more members of the group consisting of water, a halocarbon, carbon dioxide (CO₂), ammonia (NH₃), and a nonhalogenated hydrocarbon, and/or the absorbent may be one or more ionic compounds and/or non-ionic absorbents.

In a further alternative embodiment, the refrigerant pair composition of a refrigerant and an absorbent may also contain and one or more additives selected from the group consisting of polyethyleneglycol, polypropyleneglycol, zeolites, nanoparticles of less than about 100 nm in average diameter, 5- or 6-carbon ring sugars, 2-5 carbon aliphatic glycols, and mixtures thereof.

### BRIEF DESCRIPTION OF THE DRAWINGS

FIG. 1 is a schematic diagram of a simple absorption refrigeration cycle.

### DETAILED DESCRIPTION

In the description of the subject matter of this application, the following definitional structure is provided for certain terminology as employed variously in the specification:

“Alkane” refers to a saturated hydrocarbon having the general formula CₙH₂ₙ₊₂ that may be a straight-chain, branched or cyclic compound. A cyclic compound requires a minimum of three carbons.

“Alkene” refers to an unsaturated hydrocarbon that contains one or more C═C double bonds and that may be a straight-chain, branched or cyclic compound. An alkene requires a minimum of two carbons. A cyclic compound requires a minimum of three carbons.

“Aromatic” refers to benzene and compounds that resemble benzene in chemical behavior.

An “azeotropic” or “constant boiling” mixture of two or more refrigerants is a mixture wherein the composition of the vapor and liquid phases are substantially the same at a temperature and pressure encountered in a cooling or heating cycle. Included in the definition of a constant boiling mixture is a “near-azeotropic” mixture, which, as described in U.S. Pat. No. 5,709,092 maintains a substantially constant vapor pressure even after evaporative losses, thereby exhibiting constant boiling behavior.

A “fluorinated ionic compound” or a “fluorinated non-ionic absorbent” is defined as an ionic compound or a non-ionic absorbent having at least one fluorine on either the cation or the anion thereof, or in the structure thereof. A “fluorinated cation” or “fluorinated anion” is a cation or anion, respectively, that contains at least'one fluorine.

A “halocarbon” is a hydrofluorocarbon, a hydrochlorofluorocarbon, a chlorofluorocarbon, a fluorocarbon, or a mixture thereof.

“Heteroaryl” refers to an alkyl group having a heteroatom.

A “heteroatom” is an atom other than carbon in the structure of an alkanyl, alkenyl, cyclic or aromatic compound.

A “nonhalogenated hydrocarbon” is a hydrocarbon selected from the group consisting of C₁ to C₄ straight-chain, branched or cyclic alkanes and C₁ to C₄ straight-chain, branched or cyclic alkenes, or mixtures thereof.

A “refrigerant” is a fluidic substance that may be used as a thermal energy transfer vehicle. A refrigerant, when it changes phase from liquid to vapor (evaporates), removes heat from the surroundings; and when it changes phase from vapor to liquid (condenses), adds heat to the surroundings. Although the term refrigerant may carry the connotation of a substance used only for cooling, the term is used herein in the generic sense of a thermal energy transfer vehicle or substance that is applicable for use in a system or apparatus that may be used for the purpose of either heating or cooling.

The terms “refrigerant pair”, “refrigerant/absorbent pair”, “refrigerant/ionic compound” and “refrigerant/non-ionic absorbent” are used interchangeably, and refer to a mixture suitable for use in a system that operates an absorption cycle, which requires the presence of both a refrigerant and an absorbent, where the absorbent absorbs the refrigerant. As noted elsewhere herein, the absorbent in the system may be an ionic compound and/or a non-ionic absorbent. A “refrigerant pair composition” is a composition that includes a refrigerant pair, a refrigerant/absorbent pair, a refrigerant/ionic compound or a refrigerant/non-ionic absorbent.

“Vacuum” refers to pressures less than about 1 bar but greater than about 10⁻⁴ bar for practical use in absorption cycles.

### The Absorption Cycle

One aspect of the inventions hereof relates to an absorption cooling and heating system that utilizes refrigerant pairs that contain at least one refrigerant and at least one absorbent. In various embodiments of the refrigerant pair composition provided herein, the refrigerant may be water, and the absorbent may be one or more ionic compounds and/or one or more non-ionic absorbents. Other aspects of this invention provide a process for temperature adjustment, either cooling or heating, utilizing refrigerant/absorbent pairs in an absorption cooling or heating system.

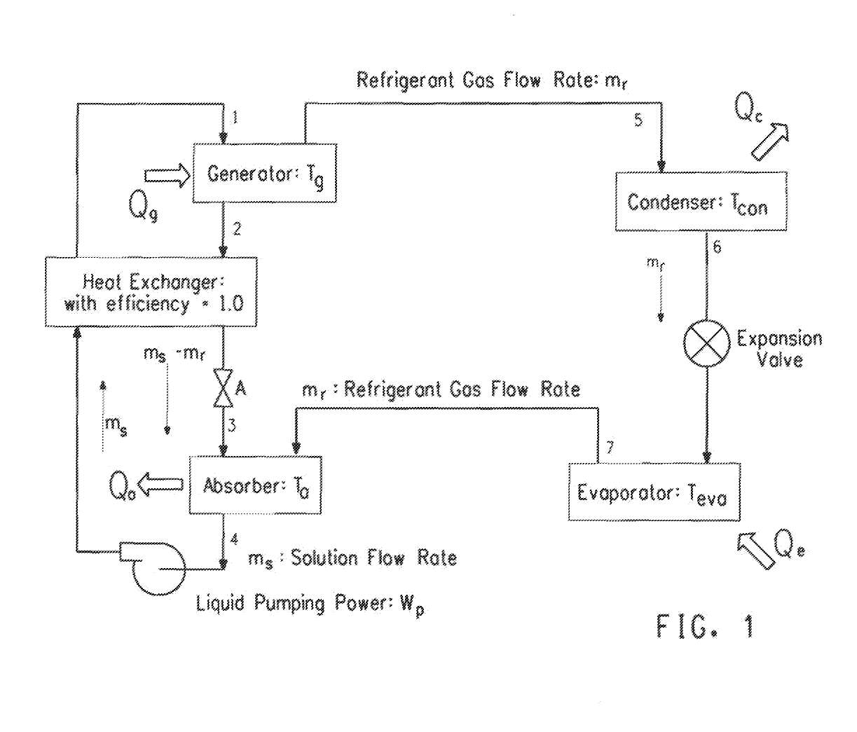

An absorption cycle, and systems in which they are run, are described in Application Guide for Absorption Cooling/Refrigeration Using Recovered Heat [Dorgan et al (American Society of Heating, Refrigeration and Air Conditioning Engineers, Inc., 1995, Atlanta Ga., Chapter 5)]. A schematic diagram for a simple absorption cycle, and the system and apparatus by which it is run, is shown in FIG. 1. The system is composed of condenser and evaporator units with an expansion valve similar to an ordinary vapor compression cycle, but an absorber-generator solution circuit replaces the compressor. The circuit may be composed of an absorber, a generator, a heat exchanger, a pressure control device and a pump for circulating the solution. In various embodiments, the heat released by the absorber upon the absorption of the refrigerant by the absorbent may be used to heat a mixture of refrigerant and absorbent in the generator to separate the refrigerant in vapor form from the absorbent.

As shown in FIG. 1, a typical apparatus for operating an absorption cycle may include components such as an absorber-generator solution circuit as shown on the left side of the drawing, which by the outflow and inflow of heat increases the pressure of refrigerant vapor as a compressor does mechanically, where the circuit may be composed of an absorber, a generator, a heat exchanger, a pressure control device and a pump for circulating the solution. The apparatus also is composed of condenser and evaporator units with an expansion valve, as shown on the right side of the drawing.

In the operation of an apparatus as shown in FIG. 1, mixture of a refrigerant and an absorbent is formed in the absorber; the mixture is passed to a generator where the mixture is heated to separate refrigerant, in vapor form, from the absorbent, and the pressure of the refrigerant vapor is increased; the refrigerant vapor is passed to a condenser where the vapor is condensed under pressure to a liquid; the liquid refrigerant is passed to an expansion device where the pressure of the liquid refrigerant is reduced to form a mixture of liquid and vapor refrigerant; the mixture of liquid and vapor refrigerant is passed to an evaporator where the remaining liquid is evaporated to form refrigerant vapor; the refrigerant vapor leaving the evaporator is passed to the absorber to repeat the first step and re-form a mixture of the refrigerant vapor and the absorbent.

An apparatus as shown in FIG. 1, and the apparatus as described in the disclosure hereof, are capable of executing an absorption cycle using the refrigerants described herein [including one or more members of the group consisting of water, a halocarbon, carbon dioxide (CO₂), ammonia (NH₃), and a nonhalogenated hydrocarbon] and/or any one or more absorbents, including for example any one or more of the ionic compounds and/or non-ionic absorbents described herein. The apparatus hereof is also capable of executing any one or more of the processes as described herein. Yet another embodiment of this invention is an apparatus substantially as shown or described in FIG. 1.

The content of the refrigerant pair composition as contained in the absorber side of the absorption cycle system will typically differ from that as contained in the generator side of the absorption cycle system. In the absorber side of the absorption cycle system, more than about 50 wt %, or more than about 70 wt %, of the refrigerant pair composition, by weight of the total composition, will typically be composed of the ionic compound(s) and/or non-ionic absorbent(s). In the generator side of the absorption cycle system, more than about 90 wt %, or more than about 95 wt %, of the refrigerant pair composition, by weight of the total composition, will typically be composed of the ionic compound(s) and/or non-ionic absorbent(s).

Another aspect of this invention provides an apparatus for heating an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser, located in proximity to the object, medium or space to be heated, that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator that receives the mixture of liquid and vapor refrigerant that passes through the pressure reduction device to evaporate the remaining liquid to form refrigerant vapor; and (f) a conduit that passes the refrigerant vapor leaving the evaporator to the absorber.

Another aspect of this invention provides an apparatus for cooling an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator, located in proximity to the object, medium or space to be cooled, that receives the mixture of liquid and vapor refrigerant that passes through the pressure reduction device to evaporate the remaining liquid to form refrigerant vapor; and (f) a conduit that passes the refrigerant vapor leaving the evaporator to the absorber.

An apparatus of this invention may be deployed for use in, or fabricated or operated as, a refrigerator, a freezer, an ice machine, an air conditioner, an industrial cooling system, a heater or heat pump. Each of these instruments may be situated in a stationary residential, commercial or industrial setting, or may be incorporated into a mobilized device such as a car, truck, bus, train, airplane, or other device for transportation, or may be incorporated into a piece of equipment such as a medical instrument.

Another aspect of this invention provides a process for heating an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid in proximity to the object, medium or space to be heated; (d) reducing the pressure of the liquid refrigerant, and evaporating the refrigerant to form refrigerant vapor; and (e) repeating step (a) to re-absorb, with the absorbent, the refrigerant vapor.

Another aspect of this invention provides a process for cooling an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid; (d) reducing the pressure of the liquid refrigerant, and evaporating the refrigerant, in proximity to the object, medium or space to be cooled, to form refrigerant vapor; and (e) repeating step (a) to re-absorb, with the absorbent, the refrigerant vapor.

Another aspect of this invention provides a process for heating an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser in proximity to the object, medium or space to be heated where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator where the remaining liquid is evaporated to form refrigerant vapor; and (f) passing the refrigerant vapor leaving the evaporator to the absorber to repeat step (a) and re-form a mixture of the refrigerant vapor and the absorbent.

Another aspect of this invention provides a process for cooling an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator in proximity to the object, medium or space to be cooled where the remaining liquid is evaporated to form refrigerant vapor; and (f) passing the refrigerant vapor leaving the evaporator to the absorber to repeat step (a) and re-form a mixture of the refrigerant vapor and the absorbent.

In any apparatus or process as described above, the absorbent and/or refrigerant may be any one or more of those described herein, and the absorbent as separated from refrigerant by the generator may be recirculated for further use in later cycles.

### Refrigerant/Absorbent Pairs—Refrigerants:

One aspect of this invention provides refrigerant pair compositions for use in an absorption cycle, which can be used for cooling, or for generating heat, depending on the application. The refrigerant used in the compositions, apparatus and processes of this invention is a refrigerant selected from one or more members of the group consisting of water, a halocarbon, carbon dioxide (CO₂), ammonia (NH₃), and a nonhalogenated hydrocarbon. Suitable halocarbons for use as a refrigerant include a hydrofluorocarbon, a hydrochlorofluorocarbon, a chlorofluorocarbon, a fluorocarbon, and mixtures thereof. In one particular embodiment, the refrigerant is water. The second member of the refrigerant pair is at least one ionic compound and/or at least one non-ionic absorbent.

Hydrofluorocarbon refrigerants suitable for use herein include compounds having any combination of hydrogen and fluorine with carbon, and include compounds with carbon-carbon double bonds with normal boiling points below 0° C. Examples of hydrofluorocarbon refrigerants suitable for use herein include difluoromethane (HFC-32), pentafluoroethane (HFC-125), 1,1,2,2-tetrafluoroethane (HFC-134), 1,1,1,2-tetrafluoroethane (HFC-134a), 1,1,1-trifluoroethane (HFC-143a), 1,1-difluoroethane (HFC-152a) and fluoroethane (HFC-1.61). Other hydrofluorocarbon refrigerants suitable for use herein may be selected from the group consisting of difluoromethane (HFC-32), pentafluoroethane (HFC-125), 1,1,1,2-tetrafluoroethane (HFC-134a), 1,1,1-trifluoroethane (HFC-143a) and 1,1-difluoroethane (HFC-152a).

Chlorofluorocarbon refrigerants suitable for use herein include compounds having any combination of chlorine and fluorine with carbon, and include compounds with carbon-carbon double bonds with normal boiling points below 0° C. One example of such a chlorofluorocarbon refrigerant includes dichlorodifluoromethane (CFC-12).

Hydrochlorofluorocarbon refrigerants suitable for use herein include compounds with any combination of hydrogen, chlorine and fluorine with carbon, and include compounds with carbon-carbon double bonds with normal boiling points below 0° C. One example of such a hydrochlorofluorocarbon refrigerant includes chlorodifluoromethane (HCFC-22).

Fluorocarbon refrigerants suitable for use herein include compounds with any combination of fluorine and carbon, and include compounds with carbon-carbon double bonds with normal boiling points below 0° C. Examples of fluorocarbon refrigerants suitable for use herein include perfluoromethane (FC-14) and perfluoroethane (FC-116).

Nonhalogenated hydrocarbon refrigerants suitable for use herein may be selected from one or more members of the group consisting of methane, ethane, ethylene, propane, cyclopropane, propylene, butane, butene and isobutane.

A refrigerant suitable for use herein may also be selected from the group consisting of water, and mixtures of water with one or more of HFC-32, HFC-125, HFC-134, HFC-134a, HFC-143a, HFC-152a, HFC-161, HCFC-22, FC-14, FC-116, CFC-12, NH₃, CO₂, methane, ethane, propane, cyclopropane, propylene, butane, butene, and isobutane.

Mixtures of refrigerants are also useful for achieving proper boiling temperature or pressure appropriate for absorption equipment. In particular, mixtures that form azeotropes or constant boiling mixtures are useful because minimal to no fractionation of the mixture will occur if the refrigerant leaks from the absorption cooling system.

### Refrigerant/Absorbent Pairs—Absorbents:

An absorbent as used in an absorption heating or cooling cycle hereof may be any one or more ionic compounds and/or any one or more non-ionic absorbents that is capable of absorbing a refrigerant. A suitable ionic compound and/or non-ionic absorbent is thus an ionic compound and/or non-ionic absorbent with which at least to some extent a refrigerant is miscible, or in which at least to some extent the refrigerant is soluble. In addition to having the ability to solubilize a refrigerant, an absorbent as used herein can also have a higher boiling point than the refrigerant. The energy efficiency of the absorption cycle will increase in direct proportion to the extent to which an ionic compound and/or non-ionic absorbent has absorption for, or is capable of solubilizing, a refrigerant (i.e. the extent to which a refrigerant has miscibility therewith or is soluble therein).

In various embodiments, ionic compounds suitable for use herein as an absorbent include ionic liquids, which are organic salts that are fluid at or below about 100° C., and preferably at or below about room temperature (about 25° C.). Many ionic liquids are formed by reacting a nitrogen-containing heterocyclic ring, preferably a heteroaromatic ring, with an alkylating agent (for example, an alkyl halide) to form a quaternary ammonium salt, and performing ion exchange or other suitable reactions with various Lewis acids or their conjugate bases to form the ionic compounds and non-ionic absorbents. Examples of suitable heteroaromatic rings include substituted pyridines, imidazole, substituted imidazole, pyrrole and substituted pyrroles. These rings can be alkylated with virtually any straight, branched or cyclic C₁₋₂₀ alkyl group, but preferably, the alkyl groups are C₁₋₁₆ groups. Various triarylphosphines, thioethers and cyclic and non-cyclic quaternary ammonium salts may also been used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany) or BASF (Mount Olive, N.J.).

Representative examples of ionic liquids suitable for use herein as an absorbent are included among those that are described in sources such as J. Chem. Tech. Biotechnol., 68:351-356 (1997); Chem. Ind., 68:249-263 (1996); J. Phys. Condensed Matter, 5: (Supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references therein cited). In one embodiment, a library, i.e. a combinatorial library, of ionic liquids may be prepared, for example, by preparing various alkyl derivatives of a quaternary ammonium cation, and varying the associated anions. The acidity of the ionic liquids can be adjusted by varying the molar equivalents and type and combinations of Lewis acids.

Ionic liquids suitable for use herein as an absorbent include those represented by the respective structures of the following formulae:

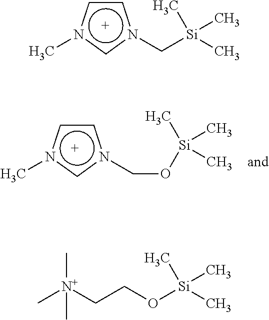

Other ionic compounds suitable for use herein as an absorbent include those that may be formed from a cation selected from one or more members of the group (Group A cations) consisting of lithium, sodium, potassium, cesium.

Other ionic compounds suitable for use herein as an absorbent include those that may be formed from a cation selected from one or more members of the group (Group B cations) consisting of the cations represented by the respective structures of the following formulae:

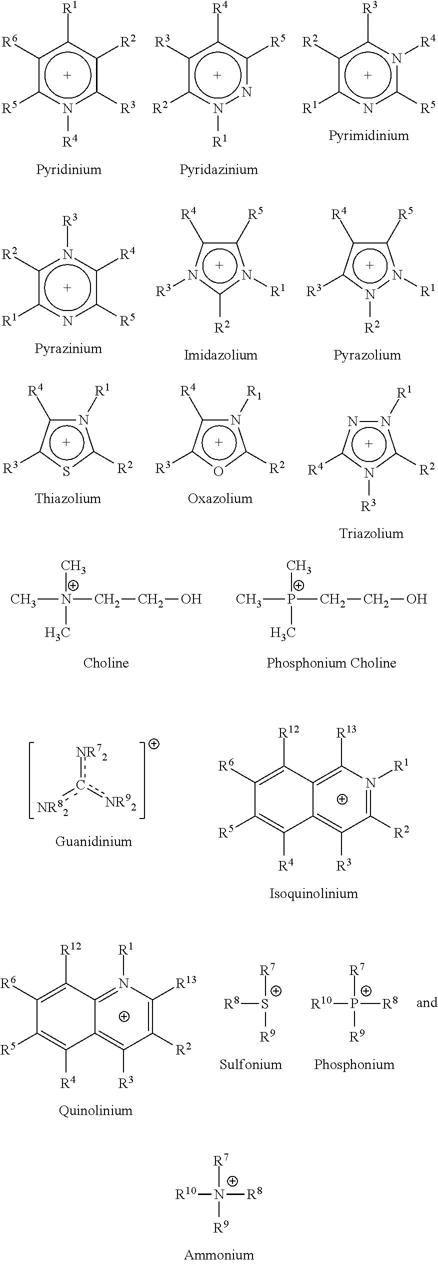

wherein R¹, R², R³, R⁴, R⁵, R⁶, R¹² and R¹³ are each independently selected from one or more members of the group consisting of:
(i) H;
(ii) halogen (e.g. F, Cl, Br, or I);
(iii) a —CH₃, —C₂H₅, or C₃ to C₂₅ straight-chain, branched or cyclic alkane or alkene group, optionally substituted with one or more of Cl, Br, F, I, OH, NH₂ and SH;
(iv) a —CH₃, —C₂H₅, or C₃ to C₂₅ straight-chain, branched or cyclic alkane or alkene group that contains one to three heteroatoms independently selected from O, N, Si and S, and optionally substituted with one or more of Cl, Br, F, I, OH, NH₂ and SH;
(v) a C₆ to C₂₀ unsubstituted aryl group, or a C₃ to C₂₅ unsubstituted heteroaryl group that contains one to three heteroatoms independently selected from O, N, Si and S;
(vi) a C₆ to C₂₅ substituted aryl group, or a C₃ to C₂₅ substituted heteroaryl group having one to three heteroatoms independently selected from O, N, Si and S; and containing one to three substituents independently selected from the group consisting of (1) OH; (2) NH₂; (3) SH; and (4) a —CH₃, —C₂H₅, or C₃ to C₂₅ straight-chain, branched or cyclic alkane or alkene group, optionally substituted with one or more of Cl, Br, F, I, OH, NH₂ and SH; and
(vii) —(CH₂)ₙSi(CH₂)ₘCH₃, —(CH₂)ₙSi(CH₃)₃, or —(CH₂)ₙOSi(CH₃)ₘ,

where n is independently 1-4 and m is independently 0-4; and

wherein R⁷, R⁸, R⁹, and R¹⁰ are each independently selected from one or more members of the group consisting of:
(viii) a —CH₃, —C₂H₅, or C₃ to C₂₅ straight-chain, branched or cyclic alkane or alkene group, optionally substituted with one or more of Cl, Br, F, I, OH, NH₂ and SH;
(ix) a —CH₃, —C₂H₅, or C₃ to C₂₅ straight-chain, branched or cyclic alkane or alkene group that contains one to three heteroatoms independently selected O, N, Si and S, and optionally substituted with one or more of Cl, Br, F, I, OH, NH₂ and SH;
(x) a C₆ to C₂₅ unsubstituted aryl group, or a C₃ to C₂₅ unsubstituted heteroaryl group that contains one to three heteroatoms independently selected from O, N, Si and S; and
(xi) a C₆ to C₂₅ substituted aryl group, or a C₃ to C₂₅ substituted heteroaryl group that contains one to three heteroatoms independently selected from O, N, Si and S; and that contains one to three substituents independently selected from the group consisting of (1) OH; (2) NH₂; (3) SH; and (4) a —CH₃, —C₂H₅, or C₃ to C₂₅ straight-chain, branched or cyclic alkane or alkene group, optionally substituted with one or more of Cl, Br, F, I, OH, NH₂ and SH; and
(xii) —(CH₂)ₙSi(CH₂)ₘCH₃, —(CH₂)ₙSi(CH₃)₃, or —(CH₂)ₙOSi(CH₃)ₘ,

where n is independently 1-4 and m is independently 0-4; and

wherein optionally at least two of R¹, R², R³, R⁴, R⁵, R⁶, R⁷, R⁸, R⁹, and R¹⁰ can together form a cyclic or bicyclic alkanyl or alkenyl group.

Particular Group B cations that are suitable for use herein include any one or more members of the group (Group B-1 cations) consisting of pyridinium, pyridazinium, pyrimidinium, pyrazinium, imidazolium, pyrazolium, thiazolium, oxazolium, triazolium, phosphonium, and ammonium.

Other Group B cations that are suitable for use herein include any one or more members of the group (Group B-2 cations) consisting of benzyltrimethylammonium, tetramethylammonium, dimethylimidazolium, and tetramethylphosphonium.

Other Group B cations that are suitable for use herein include any one or more members of the group (Group B-3 cations) consisting of choline, phosphonium choline, guanadinium, isoquinolium, quinolium, and sulfonium.

Other ionic compounds suitable for use herein as an absorbent include those that may be formed from an anion selected from one or more members of the group of anions (Group C anions) consisting of chloroaluminate, bromoaluminate, tetrachloroborate, methylsulfonate, p-toluenesulfonate, hexafluoroarsenate, tetrabromoaluminate, perchlorate, hydroxide anion, iron trichloride anion, zinc trichloride anion, gallium chloride, as well as various lanthanum, potassium, lithium, nickel, cobalt, manganese, and other metal-containing anions.

Other ionic compounds suitable for use herein as an absorbent include those that may be formed from an anion selected from one or more members of the group of anions (Group D anions) consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]⁻¹, [PO₄]³⁻, [HPO₄]²⁻, [H₂PO₄]⁻, [HSO₃]⁻, [CuCl₂]⁻, halide [Cl⁻, Br⁻, I⁻], SCN⁻, BR¹R²R⁴R⁴ or BOR¹OR²OR³OR⁴ where R¹˜R⁴ is as set forth above; carborates (1-carbadodecaborate(1−), optionally substituted with an alkyl and/or substituted alkyl group; carboranes (dicarbadodecaborate(1−), optionally substituted with an alkylamine, substituted alkylamine, alkyl and/or substituted alkyl group; and any fluorinated anion.

Fluorinated anions (Group E anions) useful herein include any one or more of [BF₄]⁻, [PF₆]⁻, [SbF₆]⁻, [CF₃SO₃]⁻, [HCF₂CF₂SO₃]⁻, [CH₃HFCCF₂SO₃]⁻; [HCClFCF₂SO₃]⁻, [(CF₃SO₂)₂N]⁻, [(CF₃CF₂SO₂)₂N]⁻, [(CF₃SO₂)₃C]⁻, [CR₃CO₂]⁻, [CF3OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [C₂ICF₂OCF₂CF₂SO₃]⁻, [CF₃CF₂OCF₂CF₂CF₂SO₃]⁻, [(CF₂HCF₂SO₂)₂N]⁻, [(CF₃CFHCF₂SO₂)₂N]⁻; and F⁻.

Other ionic compounds suitable for use herein as an absorbent include those that may be formed from an anion selected from one or more members of the group of anions (Group F anions) consisting of aminoacetate (glycine), ascorbate, benzoate, catecholate, citrate, dimethylphosphate, formate, fumarate, gallate, glycolate, glyoxylate, iminodiacetate, isobutyrate, kojate (5-hydroxy-2-hydroxymethyl-4-pyrone ion), lactate, levulinate, oxalate, pivalate, propionate, pyruvate, salicylate, succinamate, succinate, tiglate (CH₃CH═C(CH₃)COO⁻), tropolonate (2-hydroxy-2,4,6-cycloheptatrien-1-one ion).

Other ionic compounds suitable for use herein as an absorbent include those that may be formed from one or more anions (Group G anions) as represented by the structure of the following formula:

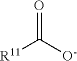

wherein R¹¹ is selected from the group consisting of:

(i) a —CH₃, —C₂H₅, or C₃ to C₁₀ straight-chain, branched or, cyclic alkane or alkene group, optionally substituted with one or more of Cl, Br, F, I, OH, NH₂ and SH;

(ii) a —CH₃, —C₂H₅, or C₃ to C₁₀ straight-chain, branched or cyclic alkane or alkene group that contains one to three heteroatoms independently selected from O, N, Si and S, and optionally substituted with one or more of Cl, Br, F, I, OH, NH₂ and SH;

(iii) a C₆ to C₁₀ unsubstituted aryl group, or a C₃ to C₁₀ unsubstituted heteroaryl group that contains one to three heteroatoms independently selected from O, N, Si and S; and

(iv) a C₆ to C₁₀ substituted aryl group, or a C₃ to C₁₀ substituted heteroaryl group that contains one to three heteroatoms independently selected from O, N, Si and S; and that contains one to three substituents independently selected from the group consisting of (1) OH; (2) NH₂; (3) SH; and (4) a —CH₃, —C₂H₅, or C₃ to C₂₅ straight-chain, branched or cyclic alkane or alkene group, optionally substituted with one or more of Cl, Br, F, I, OH, NH₂ and SH.

Other ionic compounds suitable for use herein as an absorbent include those that may be formed from one or more phosphorous-containing anions as selected from one or more members of the group of anions (Group H anions) represented by the respective structures of the following formulae, wherein R¹ and R² are as set forth above:

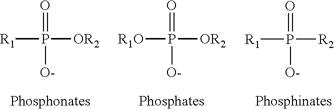

In various alternative embodiments, an ionic compound suitable for use herein as an absorbent may be formed from any one or more Group A cations and any one or more Group C, D, E, F, G and/or H anions. In further alternative embodiments, an ionic compound suitable for use herein as an absorbent may be formed from any one or more Group B cations (including Group B-1, B-2 and/or B-3 cations) and any one or more Group C, D, E, F, G and/or H anions.

Other ionic compounds suitable for use herein as an absorbent include those represented by the structure of the following formula:

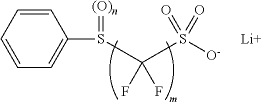

wherein n=0-2 and m=1-2,

Non-ionic compounds suitable for use herein as an absorbent include those that may be selected from one or more members of the group consisting of acrylic polymers (such as polyacrylic acid, polymethacrylic acid and polyacrylamide) and derivatives thereof; catechol (benzene-1,2-diol); crown ethers (cyclic oligomers of ethylene oxide); and pentaerythritol and substituted pentaerythritols represented by the structure of the following formula:

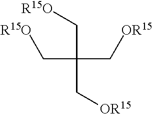

wherein R¹⁵ is H, —CH₃, —C₂H₅, or a C₃ to C₂₅ straight-chain, branched or cyclic alkane group, which may optionally be substituted with hydroxyl, carboxy, thiol, carbonyl, or amine groups.

Particular non-ionic compounds suitable for use herein as an absorbent include 12-crown-4-ether, pentaerythritol tetrakis(2-mercaptoacetate), and pentaerythritol tetrakis (3-mercaptoproprionate).

The effectiveness of any of the absorbents named herein may be enhanced by the presence in a refrigerant pair composition of one or more surfactants such as anionic surfactants including soaps, alkylbenzenesulfonates, alkyl sulfates, and alkyl phosphates; nonionic surfactants such as alkyl and alkylphenyl polyethylene glycol ethers, fatty acid alkylolamides, sucrose fatty acid esters, alkyl polyglucosides, trialkylamine oxides, perfluorooctanoate, perfluorooctanesulfonate, sodium dodecyl sulfate, sodium dodecyl sulfate, ammonium lauryl sulfate, and other alkyl sulfate salts, sodium laurel sulfate, also known as sodium lauryl ether sulfate, alkyl benzene sulfonate, or fatty acid salts; cationic surfactants including quaternary ammonium cations, tetraalkyl ammonium chloride or N-alkylpyridinium chloride; amphoteric surfactants, aminocarboxylic acids [RNH₂(+)CH₂COO(−)], betaines [(RNR₃(+)CHCOO(−)], cetyl trimethylammonium bromide, hexadecyl trimethyl ammonium bromide, and other alkyltrimethylammonium salts, cetylpyridinium chloride, polyethoxylated tallow amine, benzalkonium chloride, benzethonium chloride, zwitterionic (amphoteric), dodecyl betaine, cocamidopropyl betaine, coco ampho glycinate and sulfobetaines [(RNR₂(+)(CH₂)₃SO₃(−)]; anion cation surfactants including sodium salts of the dialkyl sulfosuccinates, and disodium salt of 1,14-disulfatotetradecane with two hydrophilic groups at both ends of a long hydrophobic residue; and nonionic surfactants including alkyl poly(ethylene oxide), alkylphenol poly(ethylene oxide), copolymers of poly(ethylene oxide) and poly(propylene oxide) (commercially called poloxamers or poloxamines), alkyl polyglucosides, including, octyl glucoside decyl maltoside fatty alcohols cetyl alcohol oleyl alcohol Cocamide MEA, cocamide DEA polysorbates: Tween 20, Tween 80 or dodecyl dimethylamine oxide

In general, when the refrigerant is water or an aqueous mixture, it would be expected to be more miscible with or soluble in ionic compounds and/or non-ionic absorbents that are hydrophilic to some extent, and ionic compounds and/or non-ionic absorbents having cations having at least one alcohol side chain, or those comprising anions having at least one acetate or sulfate group, would thus be useful choices for use in various embodiments of this invention. The refrigerant can also be miscible with or soluble in an ionic compounds and/or non-ionic absorbents as used herein over the temperature range of the operation of the absorption system, particularly from that of the evaporator to that of the generator. Evaporator temperatures can be as low as about 5° C. Single effect generator temperatures can be as high as about 150° C., while double effect generator temperatures can be as high as about 200° C. As a consequence, over a temperature range of from about 5° C. to about 200° C., a variety of different levels of the relative content of the refrigerant and absorbent in an absorption cycle are suitable, and the concentration of either the refrigerant or an ionic compounds and/or non-ionic absorbents in a composition formed therefrom may be in the range of from about 1% to about 99% by weight of the combined weight of the ionic compounds and non-ionic absorbents and the refrigerant therein.

In various embodiments of this invention, an ionic compound formed by selecting any of the individual cations described or disclosed herein, and by selecting any of the individual anions described or disclosed herein with which to pair the cation, may be used as an absorbent in an absorption heating or cooling cycle. Correspondingly, in yet other embodiments, a subgroup of ionic compounds formed by selecting (i) a subgroup of any size of cations; taken from the total group of cations described and disclosed herein in all the various different combinations of the individual members of that total group, and (ii) a subgroup of any size of anions, taken from the total group of anions described and disclosed herein in all the various different combinations of the individual members of that total group, may be used as an absorbent. In forming an ionic compound, or a subgroup of ionic compounds, by making selections as aforesaid, the ionic compounds or subgroup will be used in the absence of the members of the group of cations and/or anions that are omitted from the total group thereof to make the selection, and, if desirable, the selection may thus be made in terms of the members of the total group that are omitted from use rather than the members of the group that are included for use.

Mixtures of ionic compounds and/or non-ionic absorbents may also be used herein as the absorbent, and such mixtures may be desirable, for example, for achieving proper absorption behavior, in particular if water or other refrigerants are mixed with other components such as alcohols, esters or ethers that maybe used in combination with absorption equipment.

The effectiveness of any of the absorbents named herein may be enhanced by the presence of one or more additives selected from the group consisting of polyethyleneglycol, polypropyleneglycol, zeolites, nanoparticles of less than about 100 nm in average diameter, 5- or 6-carbon ring sugars, and 2-5 carbon aliphatic glycols. Particular additives suitable for such use include Zeolite 3A, 4A, 5A and 13X, ethylene glycol, 1,3-propanediol, 1,4-butanediol, glycerol, and silica nanoparticles.

Other additives, such as lubricants, corrosion inhibitors, stabilizers, dyes, and other appropriate materials may be added to the refrigerant pair compositions useful for the invention for a variety of purposes provided they do not have an undesirable influence on the extent to which water is soluble in an ionic compounds and non-ionic absorbents absorbent. The refrigerant pair compositions of the invention may be prepared by any convenient method, including mixing or combining the desired amounts of each component in an appropriate container using, for example, known types of stirrers having rotating mixing elements.

This invention also provides devices utilizing absorption cycles of the invention. Devices of the invention include, but are not limited to, refrigerators, car air conditioners, residential air conditioners, commercial air conditioners, transport air conditioners, commercial ice machines, transport ice machines, and industrial cooling systems.

Refrigerants and ionic compounds and non-ionic absorbents, and methods of use thereof, suitable for use in this invention are also described in U.S. Patent Publication Nos. 2006/0197053, 2007/0144186 and 2007/0019708, each of which is by this reference incorporated in its entirety as a part hereof for all purposes.

The operation and effects of certain embodiments of the invention hereof may be more fully appreciated from a series of examples, as described below. The embodiments on which these examples are based are representative only, and the selection of those embodiments to illustrate the invention does not indicate that materials, components, reactants, conditions, or techniques not described in the examples are not suitable for use herein, or that subject matter not described in the examples is excluded from the scope of the appended claims and equivalents thereof.

### EXAMPLES

### General Methods And Materials

Abbreviations used in the examples are as follows: EMIM is ethylmethylimidazolium, TMA is tetramethylammonium, and DI is deionized.

### 1. EMIM Formate by the Bicarbonate Method

EMIM bicarbonate (1.0092 g of 50% in MeOH/H₂O, Aldrich) was treated with formic acid (0.1489 g of 88% in water, J. T. Baker) at room temperature with stirring. Rapid gas evolution was observed and the mixture was stirred until completely homogeneous. Water was removed under reduced pressure, and the product obtained was a clear, viscous oil.

### 2. TMA Ascorbate by the Hydroxide Method

Tetramethylammonium hydroxide pentahydrate (1.01 g of 97%, Aldrich) was dissolved in DI water (2 mL) and treated with ascorbic acid (0.9430 g of 98%, Alfa Aesar) at room temperature with stirring until completely homogeneous. Water was removed under reduced pressure, and the product obtained was an opaque, viscous semi-solid.

### 3. Benzyltrimethylammonium Acetate by the Hydroxide Method

Benzyltrimethylammonium hydroxide (1.0135 g of 40% in water, Aldrich) was treated with glacial acetic acid (0.1453 g, EMD) at room temperature with stirring until completely homogeneous. Water was removed under reduced pressure, and the product obtained was a clear, viscous oil.

### 4. EMIM Dihydrogen Phosphate by the Chloride Method (E114261-5)

EMIM chloride (1.00 g of 95%, Fluka) was dissolved in DI water (2 mL) and treated with of potassium dihydrogen phosphate (0.93 g, Aldrich) at room temperature with stirring until completely homogeneous. Acetone (5.0 mL, VWR) was added, and a white precipitate formed that was removed by filtration. The filtrate was concentrated under reduced pressure, and the product obtained was a pale yellow oil.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage,
(a) amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value;
(b) use of the indefinite article “a” or “an” with respect to a statement or description of the presence of an element or feature of this invention, does not limit the presence of the element or feature to one in number; and
(c) the words “include”, “includes” and “including” are to be read and interpreted as if they were followed by the phrase “without limitation” if in fact that is not the case.

What is claimed is:

1. A composition comprising a refrigerant and at least one ionic compound absorbent, wherein an ionic compound comprises an anion and a cation, and the cation is selected from any one or more members of the group consisting of lithium, sodium, potassium, cesium, choline, phosphonium choline, guanadinium, isoquinolium, quinolium, and sulfonium.

2. A composition comprising a refrigerant and at least one ionic compound absorbent, wherein an ionic compound comprises an anion and a cation, and the anion is selected from any one or members of the group consisting of
(c) chloroaluminate, bromoaluminate, tetrachloroborate, methylsulfonate, p-toluenesulfonate, hexafluoroarsenate, tetrabromoaluminate, perchlorate, hydroxide anion, iron trichloride anion, zinc trichloride anion, gallium chloride, as well as various lanthanum, potassium, lithium, nickel, cobalt, manganese, and other metal-containing anions;
(d) [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, [Cl⁻, Br⁻, I⁻], SCN⁻, BR¹R²R³R⁴ or BOR¹OR²OR³OR⁴ where R¹˜R⁴ is as set forth herein; carborates (1.-carbadodecaborate(1−), optionally substituted with an alkyl and/or substituted alkyl group; carboranes (dicarbadodecaborate(1−), optionally substituted with an alkylamine, substituted alkylamine, alkyl and/or substituted alkyl group;
(f) aminoacetate (glycine), ascorbate, benzoate, catecholate, citrate, dimethylphosphate, formate, fumarate, gallate, glycolate, glyoxylate, iminodiacetate, isobutyrate, kojate (5-hydroxy-2-hydroxymethyl-4-pyrone ion), lactate, levulinate, oxalate, pivalate, propionate, pyruvate, salicylate, succinamate, succinate, tiglate (CH₃CH═C(CH₃)COO⁻), tropolonate (2-hydroxy-2,4,6-cycloheptatrien-1-one ion);
(g) anions represented by the structure of the following formula: 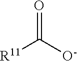
wherein R¹¹ is selected from the group consisting of:
(i) a —CH₃, —C₂H₅, or C₃ to C₁₀ straight-chain, branched or cyclic alkane or alkene group, optionally substituted with one or more of Cl, Br, F, I, OH, NH₂ and SH;
(ii) a —CH₃, —CH₂H₅, or C₃ to C₁₀ straight-chain, branched or cyclic alkane or alkene group that contains one to three heteroatoms independently selected from O, N, Si and S, and optionally substituted with one or more of Cl, Br, F, I, OH, NH₂ and SH;
(iii) a C₆ to C₁₀ unsubstituted aryl group, or a C₃ to C₁₀ unsubstituted heteroaryl group that contains one to three heteroatoms independently selected from O, N, Si and S; and
(iv) a C₆ to C₁₀ substituted aryl group, or a C₃ to C₁₀ substituted heteroaryl group that contains one to three heteroatoms independently selected from O, N, Si and S; and that contains one to three substituents independently selected, from the group consisting of (1) OH; (2) NH₂; (3) SH; and —CH₃, —C₂H₅, or C₃ to C₂₅ straight-chain, branched or cyclic alkane or alkene group, optionally substituted with one or more of Cl, Br, F, I, OH, NH₂ and SH; and
(h) anions represented by the respective structures of the following formulae, wherein R¹ and R² are as set forth herein:

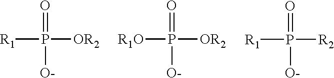

3. A composition comprising a refrigerant and at least one non-ionic absorbent, wherein the non-ionic absorbent is selected from one or more of acrylic polymers (such as polyacrylic acid, polymethacrylic acid and polyacrylamide) and derivatives thereof; catechol (benzene-1,2-diol); crown ethers (cyclic oligomers of ethylene oxide); and pentaerythritol and substituted pentaerythritols represented by the structure of the following formula: 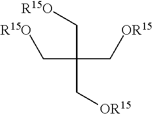
wherein R¹⁵ is H, —CH₃, —C₂H₅, or C₃ to C₂₅ straight-chain, branched or cyclic alkane, optionally substituted with hydroxyl, carboxy, thiol, carbonyl, or amine groups.

4. A composition comprising a refrigerant, at least one ionic compound absorbent and/or non-ionic absorbent, and one or more additives selected from the group consisting of polyethyleneglycol, polypropyleneglycol, zeolites, nanoparticles of less than about 100 nm in average diameter, 5- or 6-carbon ring sugars, and 2-5 carbon aliphatic glycols.

5. The composition of claim 1, 2, 3 or 4 wherein the refrigerant is selected from one or more members of the group consisting of water, a halocarbon, carbon dioxide (CO₂), ammonia (NH₃), and a nonhalogenated hydrocarbon.

6. An apparatus for temperature adjustment comprising (a) an absorber that forms a mixture of a refrigerant and an absorbent (b) a generator that receives the mixture from the absorber and heats the mixture to separate refrigerant, in vapor form, from the absorbent, and increases the pressure of the refrigerant vapor; (c) a condenser that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator that receives the mixture of liquid and vapor refrigerant that passes through the pressure reduction device to evaporate the remaining liquid to form refrigerant vapor; and (f) a conduit that passes the refrigerant vapor leaving the evaporator back to the absorber; wherein the absorbent and refrigerant comprise a composition according to claim 1, 2, 3 or 4,

7. The apparatus of claim 6 wherein the condenser is located in proximity to an object, medium or space to be heated.

8. The apparatus of claim 6 wherein the evaporator is located in proximity to an object, medium or space to be cooled.

9. A process for adjusting the temperature of an object, medium or a space comprising (al absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid; (d) reducing the pressure of the liquid refrigerant, and evaporating the refrigerant to form refrigerant vapor; and (e) repeating step (a) to re-absorb, with the absorbent, the refrigerant vapor; wherein the absorbent and refrigerant comprise a composition according to claim 1, 2, 3 or 4.

10. The process of claim 9 wherein refrigerant vapor is condensed to a liquid in proximity to an object, medium or space to be heated,

11. The process of claim 9 wherein liquid refrigerant is evaporated to form refrigerant vapor in proximity to an object, medium or space to be cooled.
